(19) United States
(12) Patent Application Publication
(10) Pub. No.: US 2013/0035956 A1
(43) Pub. Date: Feb. 7, 2013

(54) VISUALIZATION OF PATIENT TREATMENTS

(71) Applicants: Boaz Carmeli, Koranit (IL); Carmel Gerda Kent, Zippori (IL); Yonatan Maman, Hof Hacarmel (IL); Yoav Rubin, Haifa (IL); Noam Slonim, Jerusalem (IL)

(72) Inventors: Boaz Carmeli, Koranit (IL); Carmel Gerda Kent, Zippori (IL); Yonatan Maman, Hof Hacarmel (IL); Yoav Rubin, Haifa (IL); Noam Slonim, Jerusalem (IL)

(73) Assignee: International Business Machines Corporation, Armonk, NY (US)

(21) Appl. No.: 13/195,870

(22) Filed: Aug. 2, 2011

(51) Int. Cl. G06Q 50/24

(52) U.S. Cl. 705/3

(57) ABSTRACT

Method, system, and computer program product for visualization of patient treatments are provided. The method includes: selecting a patient; retrieving data records of patients with similar conditions requiring treatment to the selected patient; and building a tree structure for display with nodes of treatment options and a temporal axis showing treatment results of the similar patients. The tree structure includes representing side effects of a treatment option at a node including a visualization of the strength of the side effect. The tree structure also includes providing edges between the nodes representing a length to progression of the condition requiring treatment.

### BACKGROUND

This invention relates to the field of medical treatment of patients. In particular, the invention relates to visualization of patient treatments.

Medical treatment of diseases or injuries to patients may have multiple possible courses of treatment. Treatment of cancer is one of the most difficult and complex with different options which may be selected by a medical practitioner.

For most cancers, medicine has an initial protocol of care. This is usually a form of tumor removal and some form of preventative (adjuvant) medication and/or radiation. This is true for the most common forms of cancer like prostate, breast and colorectal cancers. If the cancer returns and metastasizes to other organs (e.g., liver, lungs, brain, bones, etc.) the oncologists usually start an educated guessing game. They have a list of treatments that they can fight the disease with and they begin to apply them in combination or one-at-a-time to the disease. The experienced oncologist will try to optimize the drug “ammunition” according to a set of requirements like patient quality of life (less side effects), extending survival (more side effects, probably increased cost), cost effectiveness, etc.

When there is no protocol and several drugs to choose from, the oncologist uses previous experience and published research to decide which drug to give at a given time. Drug effectiveness is usually measured in mean time-to-progression and this may vary between zero (where the drug does not have any effect) to several years (where a patient has a good response to the drug).

This decision, however critical and affecting as it is, is based on the experience and the relevant literature familiar to the oncologist. Still, there is no visual manner to present the relevant clinical information in a concise and dynamic manner, to allow both oncologists and patients to choose the right treatment path based on the parameters which are most relevant for the patient (e.g., aggressiveness of treatment versa quality of life).

Nowadays, electronic medical records are becoming more and more available and used, it is possible to use data found within an organization, publicly available electronic data, or purchasable medical data, to help in finding the best treatment for the patient. Common solutions to visualize available data and make it usable and consumable are based on textual or tabular representation, which by its nature is not easy to use and therefore not used as often as it might be.

There is a need to provide the proper visualization of the relevant medical/clinical data to allow doctors find the best treatment for their patients.

### BRIEF SUMMARY

According to a first aspect of the present invention there is provided a method for visualization of patient treatments, comprising: selecting a patient; retrieving data records of patients with similar conditions requiring treatment to the selected patient; building a tree structure for display with nodes of treatment options and a temporal axis showing treatment results of the similar patients; wherein said steps are implemented in either: computer hardware configured to perform said steps, or computer software embodied in a non-transitory, tangible, computer-readable storage medium.

According to a second aspect of the present invention there is provided a computer program product for visualization of patient treatments, the computer program product comprising: a computer readable storage medium having computer readable program code embodied therewith, the computer readable program code comprising: computer readable program code configured to: select a patient; retrieve data records of patients with similar conditions requiring treatment to the selected patient; and build a tree structure for display with nodes of treatment options and a temporal axis showing treatment results of the similar patients.

According to a third aspect of the present invention there is provided a system for visualization of patient treatments, comprising: a processor; a patient selector for selecting a patient; a search component for retrieving data records of patients with similar conditions requiring treatment to the selected patient; and a tree builder component for building a tree structure for display with nodes of treatment options and a temporal axis showing treatment results of the similar patients.

According to a fourth aspect of the present invention there is provided a method of providing a service to a customer over a network for visualization of patient treatments, the service comprising: selecting a patient; retrieving data records of patients with similar conditions requiring treatment to the selected patient; and building a tree structure for display with nodes of treatment options and a temporal axis showing treatment results of the similar patients.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system in accordance with the present invention;

FIG. 2 is a block diagram of a computer system in which the present invention may be implemented;

FIG. 3 is a flow diagram of a method in accordance with the present invention; and

FIG. 4 is a schematic diagram of a visualization display in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Method, system and computer program product are described in which visual representation of treatment options for a patient is provided by mapping with treatment options selected by other patients with similar conditions requiring treatment for facilitating personalized treatment. Conditions requiring treatment may include diseases, particularly diseases such as cancer where there are many treatment options, injury, or disability, or any other condition which requires treatment. The term treatment may include administered medicine, surgery, therapy, or any other method of treating a condition. A treatment option may be to give no treatment.

More specifically, one or more treatments for a patient may be displayed over a period of time, including one or more treatment options and results including side effects of the treatments. The treatments may be displayed in a tree form with a representation indicating side effects, age, life expectancy etc. Each node may display beside it the set of possible side effects, this may include a display that represents the aggressiveness of the treatment and therefore the strength of the side effect. For example, the display may be colour coded, may include images, icons, or may have a font variation such as size, weight, colour, etc. The form of display may be configured by a user.

The temporal axis of the tree structure shows treatment results on a time basis which is important in order to differentiate between different treatment paths. The time basis of the treatment results is a prediction of the time to progression of the condition based on (but not limited to) the data of similar patients.

A tree structure representation may be provided of the possible treatments, in a way that shows the possible treatment as the tree nodes with their expected time to progression as the difference along the temporal axis between nodes. The time to progression is the time period until the treatment is no longer effective. This may be if condition in the form of a disease starts to progress again, or any other medical indicator shows that a treatment is not useful, even if the disease itself has not started to progress again.

The set of edges coming out of a node may be represented (for example, colour coded or modified transparency) to show the percentage of uses of that edge (e.g., an edge from A to B is color coded to show how many people that were at state A choose the treatment B). As well as for each edge, further information may be presented to show for each usage of the edge what the result was of using that edge and when that treatment stopped affecting the patient. For example, statistical information may be provided or visualized using such techniques as graphs, scatter plots, pie charts, bar charts, etc. The information may be based on a compilation of markers, patient's general health, etc.

The advantage of using this solution is that all or a selected set of possible treatments are presented in a way that each treatment's pros and cons are easy to understand and to compare. Future treatment routes (not limited to only the next step) may be viewed thus enabling a long term treatment plan to be decided on. All possible treatment paths may be seen and evaluated while reducing a medical practitioner's need to remember them all. Additionally, personalized treatments may be displayed and configured by input from the user, and thus allow a treatment to be offered that suits not only the patient's clinical state but also other considerations that may be out of the scope of the clinician (such as refusal to undergo a specific treatment due to unwanted side-effects).

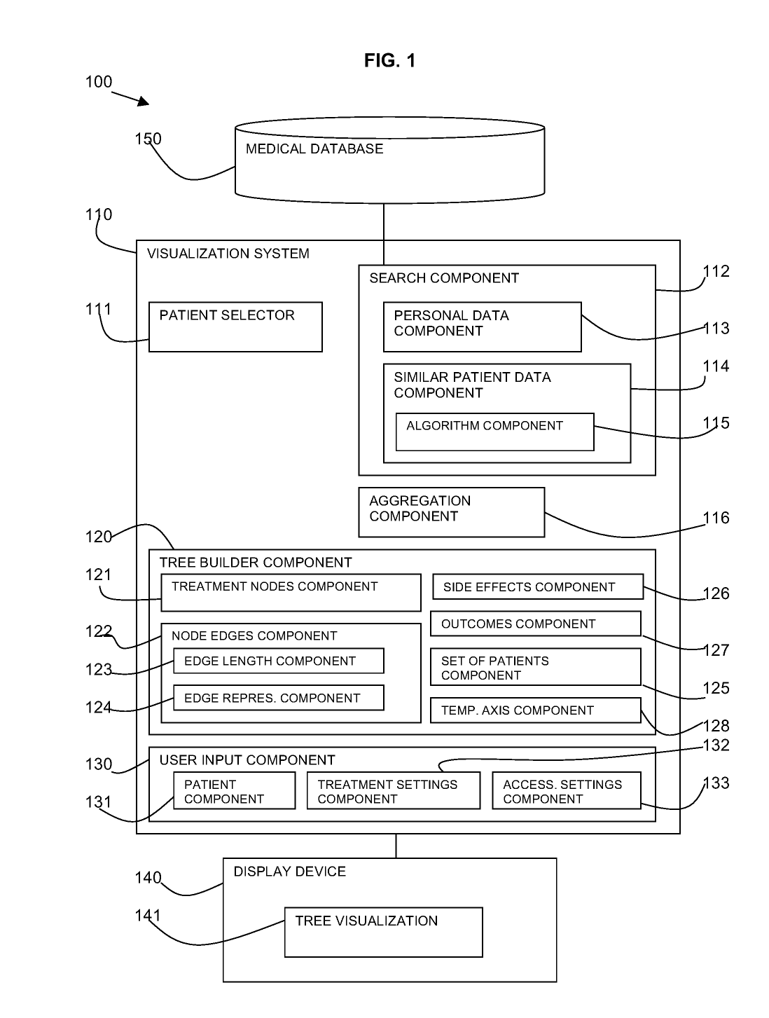

Referring to FIG. 1, a block diagram shows an embodiment of the described system 100. The system 100 includes a visualization system 110 which may have access to a medical database 150 storing medical data records for patients. The visualization system 110 may have direct access to a medical database 150, for example, in an organization's system, or may access a medical database 150 via a network. The visualization system 110 may access multiple medical databases 150 or other data sources (for example, files, web based services, published results, etc).

The visualization system 110 may include a patient selector 111 for selecting a patient for which treatment visualization is to be provided. The patient selector 111 may be a user login.

A search component 112 may be provided including a personal data component 113 for searching or retrieving medical data records for the selected patient from the medical database 150. The search component 112 may also include a similar patient data component 114 for searching for medical data records relating to patients with similar conditions to the selected patient. The similar patient data component 114 may include an algorithm component 115 for applying various algorithms on the medical database 150 to find patients with similar data records. The similar patient data component 114 may use other parameters as well as similar condition, such as similar family background, genetic similarity, etc.

An aggregation component 116 may aggregate the retrieved data record results and may provide the aggregated results to a tree builder component 120.

The tree builder component 120 may include various components relating to the aspects of the tree visualization to be built. These components may be varied depending on the visualization requirements. A treatment nodes component 121 may be provided which defines nodes of the tree relating to different treatment options. A temporal axis component 128 may provide a temporal axis of a suitable time frame to illustrate treatment progression through multiple courses of treatment. The temporal axis component 128 may provide a vertical or horizontal axis to which the tree visualization is aligned.

A node edges component 122 may be provided for illustrating a route through the treatment nodes including an edge time component 123 for determining a length of edge in order for the difference along a temporal axis of the tree structure between nodes joined by the edge to relate to the expected treatment time to progression. The node edges component 122 may include an edge representation component 124 for indicating by representation of the edge (for example, by different colours or shading) a percentage of the patients using that edge.

A set of patients component 125 may be provided which defines the patients for which the aggregated results have been obtained. A side effects component 126 may be provided for determining the side effects of treatments and may provide a ranking of the strength of the side effects. An outcomes component 127 may be provided for determining the outcome of patients using a treatment.

A user input component 130 may be provided for inputting user preferences to the tree builder component 120. The user input component 130 may include a patient component 131 for restricting or widening the net for similar patients whose results are used in the tree builder component 120. This may be done by varying the selected patient's parameters of age, disease parameters, etc. The user input component 130 may also include a treatment settings component 132 for restricting treatment options for the selected patient. For example, by excluding or allowing forms of administration and side effects.

The user input component 130 may include an accessibility settings component 133 for a user to set how different aspects of the tree visualization 141 are represented and other accessibility is provided. This may be necessary if a user is colour blind, or has difficulty reading small fonts, or may be just for a preference of visualization. For example, accessibility settings may include display settings including the form of the nodes and what information the nodes show, the form and representation of the edges, the additional information shown relating to the edges, the side effects representation and the representation of the strength of the side effects, the time period shown by the tree visualization alongside the temporal axis, etc. Accessibility settings may also include, for example, use of icons instead of colours, usage of text, size of font, etc.

A display device 140 is provided for displaying the resultant tree visualization 141 as generated by the tree builder component 120 for a selected patient.

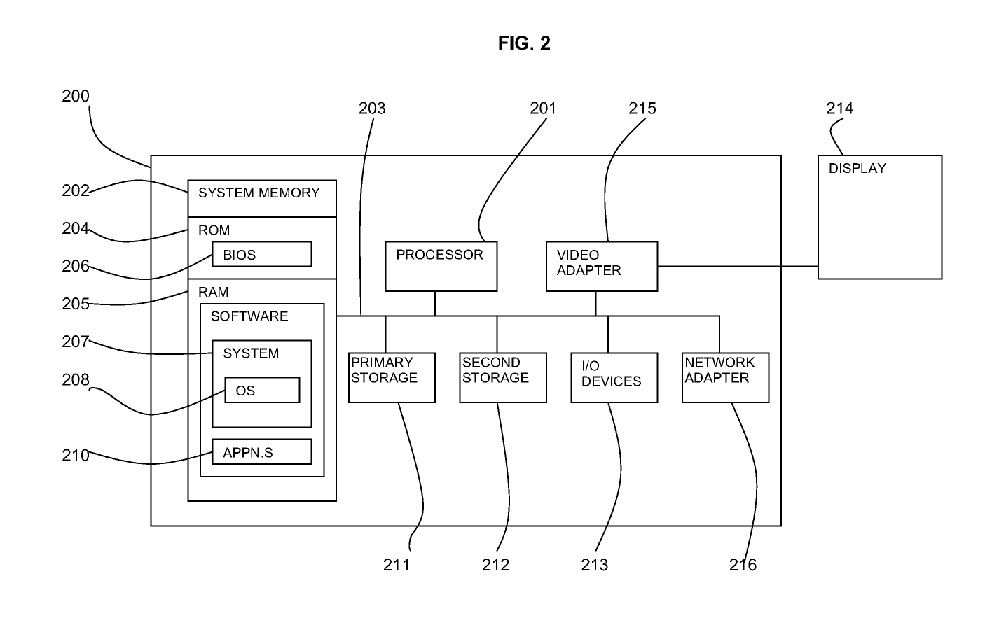

Referring to FIG. 2, an exemplary system for implementing aspects of the invention includes a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

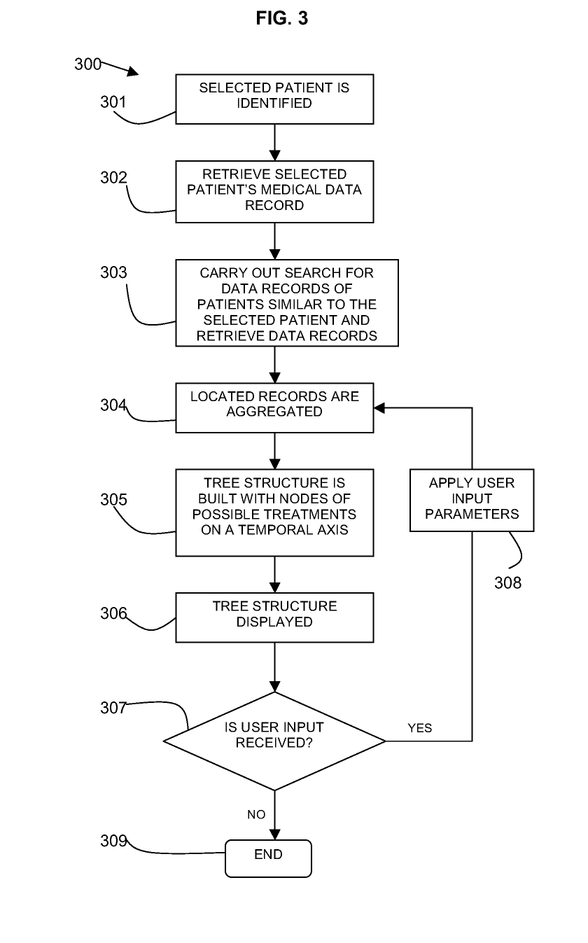

Referring to FIG. 3, a flow diagram 300 shows an embodiment of the described method.

A selected patient is identified 301 (for example, by a user logging in to the system or providing a user ID, or patient details entered) and the selected patient's personal medical data record is retrieved 302.

A search is carried out 303 of a data set of medical records to find data records of similar patients (i.e. patients with similar conditions) and the medical data records are retrieved. One or more algorithms may be applied on an entire data set of an organization to find the similar data records. Similarity may be detected using comparison of various features of the patient (such as age, medical history or genetic markers.) or disease specific features (such as size of the tumour, its location, its specific genetic markers etc.)

The located records may be aggregated 304 to construct the data needed to build the tree of possible treatments as well as the associated graphs that show the possible outcome and the ranking of side effects.

A tree structure is built 305 with nodes of possible treatments on a temporal axis. The general structure of the data behind the tree is provided and adapted to each patient.

The nodes may have associated rankings of side effects which may be colour coded or otherwise represented by strength. Edges of the nodes may indicate treatment popularity (for example, by edge colour) and expected time of treatment (for example, by distance between nodes), and associated graphs of outcomes (for example, a scatter graph of patients).

Once the adaptation process is done, the tree structure is displayed 306 as a visualization on a screen. It may be determined 307 if user input is received. If so, user input parameters are applied 308 to the aggregated records 304 and the method loops to display a new tree structure or display an amended tree structure.

The user input may widen or restrict the set of patients with which the patient is compared by selecting parameters relating to the patient such as the patients' age range, medical history, the relevant medical state (for example, the disease identifying parameters such as genetic markers which may be used which help the medical practitioner decide which drugs to use). Parameters relating to the condition itself may also be selected (for example, in the case of a cancer patient, the size of a tumour, the location of a tumour, and the genetic markers of the tumour, etc.).

The user input may also provide an allowed set of treatments conditions (for example, method of administration of drugs, side effects, etc). This allows the user to have control over some of the visualized treatment options. For example, if a patient is the user and he is finds the side effect of nausea debilitating, or if a patient prefers intravenous administration instead of oral administration of drugs, the treatment options can be visualized accordingly.

If no user input is received, or no further user input received, the method ends 309 with a finally displayed tree visualization of treatment courses. Multiple tree visualizations may be provided with different user inputs for comparison purposes.

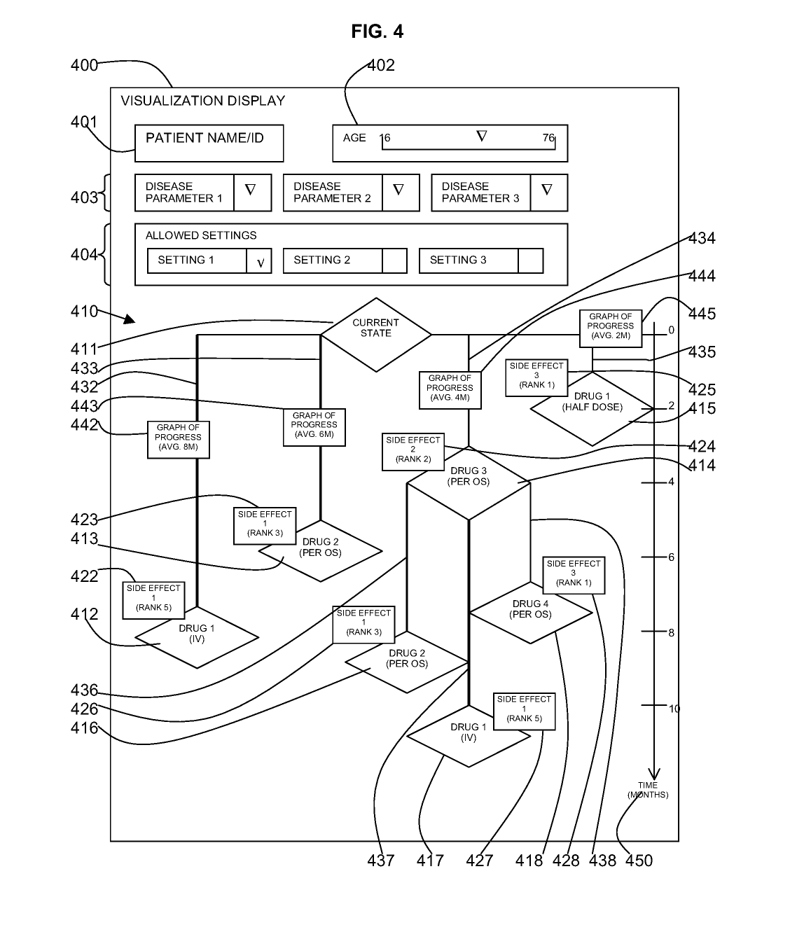

Referring to FIG. 4, a schematic diagram shows an embodiment of a visualization display 400. The display 400 includes a patient's name or ID 401 for input of the selected patient to which the display relates.

The display may include an input means for the patient's age 402 which may be a sliding scale of ages or selectable age ranges.

The display 400 may include one or more disease parameters 403 which may have selectable drop down menus for selecting parameter options for defining the disease parameters.

The display 400 may include one or more allowed settings 404 which may be selected/unselected by a user. For example, settings may include side effects such as cardiotoxicity, hair loss, nausea, etc. or method of administration such as intravenous (IV), oral administration (per os), etc.

A tree structure 410 is provided in the display 400 illustrating treatment options and results for the selected patient based on the medical records of patients with similar conditions. The tree structure 410 shown in FIG. 4 is an example of how the tree may be represented. Alternative representations of the nodes, edges, additional information, side effects, etc. may be used and may be selected by a user. For example, if a user is colour blind, colour representations of side effects will not be useful and alternative representations should be used (such as using different icons, fonts, text, etc.).

The tree structure 410 has a temporal axis 450. In this example embodiment, the temporal axis 450 is in 2 month intervals from an initial current state 411.

The tree structure 410 has nodes 412-418 representing treatment options. Each node 412-418 may have an associated representation of side effects 422-428. The representation of side effects 422-428 may have a ranking of the strength of the side effect which may be shown in a grading of shade or a colour for a given side effect.

For example, node 412 is for drug 1 administered by IV which is shown to have side effect 1 of rank 5 (ranking 1 to 5 with 5 being the strongest or most difficult side effect). This may be a side effect of nausea and vomiting of high strength. If the side effect of nausea and vomiting is given a colour of grey (for example), the side effect representation 422 may be a dark grey color showing at a glance that the treatment option of node 412 has a strong unpleasant side effect.

As another example, node 418 is for drug 4 administered orally which is shown to have side effect 3 of rank 1. This may be side effect of light nausea of weak strength. If the side effect of light nausea is given a color of green (for example), the side effect representation 428 may be a light green color showing at a glance that the treatment option of node 418 has a relatively light side effect.

The side effects representations 422-428 may be incorporated into the node 412-418 itself, or represented as an adjacent box, or shown when hovering over the node 412-418.

The edges 431-438 may also represent aspects of the treatment options and results. The length of edges 431-438 incoming into a node 411-418 may represent by the distance between the nodes along the temporal axis 450 the expected time to progression or life expectancy time.

The edges 431-438 coming out of a node 411-418 may be represented to indicate the percentage of patients using that edge. The representation of the edge may be in color or graduated shading, thickness of line, etc. For example, the percentage of patients taking node 412 from the current state 411 is 45% shown as a thick line edge 432, the percentage of patients taking node 423 is 30% shown as a medium-thick line edge 433, the percentage of patients taking node 424 is 20% shown as a medium-light line edge 434, and the percentage of patients taking node 425 is 5% shown as a light line edge 435. The same applies to the edges 436-438 coming out of node 414 in a lower branch of the tree structure 410.

In addition, an edge 431-438 may have a graphical representation 442-445 or other information associated with it. The graphical representation 442-445 may be, for example, a scatter chart showing a score of the disease as a function of time since the treatment began with each patient represented by a dot.

A treatment visualization system may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like, conventional procedural programming languages, such as the “C” programming language or similar programming languages, or any other suitable programming paradigm. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for visualization of patient treatments, comprising:
selecting a patient;
retrieving data records of patients with similar conditions requiring treatment to the selected patient;
building a tree structure for display with nodes of treatment options and a temporal axis showing treatment results of the similar patients;

2. The method as claimed in claim 1, wherein the temporal axis showing treatment results shows a prediction of the time to progression of a condition based on the data records of similar patients.

3. The method as claimed in claim 1, including aggregating the similar patients data records to determine treatment options and results.

4. The method as claimed in claim 1, wherein building a tree structure includes: representing side effects of a treatment option at a node.

5. The method as claimed in claim 4, wherein representing side effects includes a visualization of the strength of the side effect.

6. The method as claimed in claim 1, wherein building a tree structure includes: providing edges between the nodes, wherein an edge incoming to a node treatment represents with respect to the temporal axis a time to progression of the condition requiring treatment.

7. The method as claimed in claim 1, wherein building a tree structure includes: providing edges between nodes with the representation of the edge outcoming from a node treatment represents the percentage of the similar patients using the node treatment option.

8. The method as claimed in claim 1, wherein building a tree structure includes: providing edges between the nodes, wherein an edge has associated information on the results of the similar patients.

9. The method as claimed in claim 8, wherein the associated information is in graph form.

10. The method as claimed in claim 1, wherein selecting a patient retrieves a patient's medical data record from a data source.

11. The method as claimed in claim 1, wherein retrieving data records of patients with similar conditions requiring treatment to the selected patient includes applying algorithms for condition parameters of patients.

12. The method as claimed in claim 1, including receiving user input to amend the set of treatment nodes by allowing or refusing treatment settings.

13. The method as claimed in claim 12, wherein the treatment settings include one or more of the group of: side effects, methods of administration.

14. The method as claimed in claim 1, including receiving user input to amend the set of retrieved data records of similar patients by amending condition parameters.

15. The method as claimed in claim 14, wherein the condition parameters include one or more of the group of: patient age, medical history, disease or injury parameters including genetic markers.

16. A computer program product for visualization of patient treatments, the computer program product comprising:
a computer readable storage medium having computer readable program code embodied therewith, the computer readable program code comprising:
computer readable program code configured to:
select a patient;
retrieve data records of patients with similar conditions requiring treatment to the selected patient; and
build a tree structure for display with nodes of treatment options and a temporal axis showing treatment results of the similar patients.

17. A system for visualization of patient treatments, comprising:
a processor;
a patient selector for selecting a patient;
a search component for retrieving data records of patients with similar conditions requiring treatment to the selected patient; and
a tree builder component for building a tree structure for display with nodes of treatment options and a temporal axis showing treatment results of the similar patients.

18. The system as claimed in claim 17, wherein the tree builder component includes a side effects component for representing side effects of a treatment option at a node.

19. The system as claimed in claim 17, wherein the tree builder component includes a node edges component providing edges between the nodes, wherein an edge incoming to a node treatment represents with respect to the temporal axis a time to progression of the condition requiring treatment.

20. The system as claimed in claim 19, wherein the node edges component provides edges between nodes with the representation of the edge outcoming from a node treatment represents the percentage of the similar patients using the node treatment option.

21. The system as claimed in claim 19, wherein the node edges component provides associated information with an edge, wherein the associated information relates to the results of the similar patients.

22. The system as claimed in claim 17, wherein the search component includes an algorithm component for applying algorithms for condition parameters of patients.

23. The system as claimed in claim 17, including a user input component for receiving user input to amend the set of treatment nodes by allowing or refusing treatment settings.

24. The system as claimed in claim 17, including a user input component for receiving user input to amend the set of retrieved data records of similar patients by amending condition parameters.

25. A method of providing a service to a customer over a network for visualization of patient treatments, the service comprising:
selecting a patient;
retrieving data records of patients with similar conditions requiring treatment to the selected patient; and
building a tree structure for display with nodes of treatment options and a temporal axis showing treatment results of the similar patients.
